(19) United States
(12) Patent Application Publication
(10) Pub. No.: US 2015/0247931 A1
(43) Pub. Date: Sep. 3, 2015

(54) LOCALLY ENHANCED GNSS WIDE-AREA AUGMENTATION SYSTEM

(71) Applicant: Hemisphere GNSS Inc., Scottsdale, AZ (US)

(72) Inventor: RODRIGO LEANDRO, SCOTTSDALE, AZ (US)

(73) Assignee: Hemisphere GNSS Inc., Scottsdale, AZ (US)

(21) Appl. No.: 14/633,346

(22) Filed: Feb. 27, 2015

Related U.S. Application Data
(60) Provisional application No. 61/946,272, filed on Feb. 28, 2014.

(51) Int. Cl. G01S 19/07

(52) U.S. Cl. CPC G01S 19/07

(57) ABSTRACT

A locally enhanced GNSS wide-area augmentation system is provided. The system includes a global reference processing center and a wide-area reference network formed of wide-area reference stations and GNSS satellites. The global reference processing center is in communication with the wide-area reference network in order to receive global network data and form global correction data. The system also includes a local reference processing center and a local reference network having reference stations and a rover receiver that communicate with GNSS satellites. The local reference processing center is in communication with the local reference network in order to receive local network data and form local enhancement data. The system also includes a communication link to send correction data formed of global correction data and local enhancement data to the rover receiver.

### CROSS REFERENCE TO RELATED APPLICATION[S]

This application which claims priority to U.S. Provisional Patent Application entitled “LOCALLY ENHANCED GNSS WIDE-AREA AUGMENTATION SYSTEM,” Ser. No. 61/946,272, filed Feb. 28, 2014, the disclosure of which is hereby incorporated entirely herein by reference.

### BACKGROUND

GNSS (Global Navigation Satellite System) positioning consists of the computation of the position of the antenna of a GNSS receiver using signals that are received from GNSS satellites. In order to perform such computation of the position of the antenna of a GNSS receiver, one or more GNSS satellite can be used. Current examples of GNSS are the GPS (Global Positioning System), GLONASS (Global Navigation Satellite System), BeiDou, and Galileo, created and maintained by the US, Russia, China, and European Union, respectively.

The position performance that can be achieved using GNSS depends on several factors, such as Quality of the receiver hardware, including antenna; Interference level in the environment surrounding the receiver antenna; Atmospheric activity; Number of satellites being used; Quality of the satellite clock and modulation; Number of signals per satellite being used; Quality of the data processing algorithms; and Nature and quality of the information used to model the observation data (often called correction data).

When operating autonomously, GNSS receivers used information broadcast by each GNSS control segment in order to model the signal observables. This information is contained in what is often referred to as broadcast ephemeris. The broadcast ephemeris data sent as part of the satellite signals typically delivers meter-level positions when used to process observations. Because there is a great demand for position accuracies better than a meter in several applications, several techniques were developed aiming at augmenting GNSS performance by generating, transmitting and employing high accuracy correction data. Each of these techniques lack in ability to accurately reflect the position of a GNSS receiver.

Accordingly, because of the limitations of existing systems, a new locally enhanced GNSS wide-area augmentation system is needed.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a single base station local correction;

FIG. 2 is a diagrammatic view of multiple base stations regional correction;

FIG. 3 is a diagrammatic view of a multiple station wide-area correction;

FIG. 4 is a diagrammatic view of a multiple station wide-area global correction;

FIG. 5 is a diagrammatic view of a radio as a communication means for GNSS corrections;

FIG. 6 is a diagrammatic view of Internet as a communication means for GNSS corrections;

FIG. 7 is a diagrammatic view of a satellite communication as a communication means for GNSS corrections;

FIG. 8 is a view of GNSS measurement components and line-of-sight correction model;

FIG. 9 is a view of GNSS measurement components and two sources of line-of-sight correction model;

FIG. 10 is a view of GNSS measurement components and a satellite effects correction model;

FIG. 11 is a view of GNSS measurement components and a wide-area correction model including atmospheric modelling;

FIG. 12 is a view of GNSS measurement components and a regional correction model;

FIG. 13 is a diagrammatic view of a dataflow of a wide-area correction with the local enhancement correction of one location;

FIG. 14 is a diagrammatic view of a dataflow of a wide-area correction with the local enhancement correction of one location;

FIG. 15 is a diagrammatic view of a dataflow of a wide-area correction with the local enhancement correction of one location using Internet;

FIG. 16 is a diagrammatic view of a dataflow of a wide-area correction with the local enhancement correction of one location, using communication satellite and Internet;

FIG. 17 is a view of a combination of wide-area correction with the local enhancement correction of one location;

FIG. 18 is a view of a combination of a wide-area correction with the local enhancement correction of two locations;

FIG. 19 is a view of a combination of a wide-area correction with the local enhancement correction of two locations;

FIG. 20 is a view of a combination of wide-area corrections with local enhancement corrections generated at different rates; and

FIG. 21 is a flow chart depicting a method of processing GNSS data to form locally enhanced GNSS wide-area corrections.

### DETAILED DESCRIPTION OF EMBODIMENTS OF THE INVENTION

Embodiments of the present invention include a locally enhanced GNSS wide-area augmentation system that performs a method of processing GNSS data derived from observations at one or more stations, of GNSS signals of multiple satellites, comprising obtaining a set of wide-area correction parameters; generating a local correction to the wide-area correction; and making available the local correction data.

### Conventional Correction Techniques

Some of the several modalities of GNSS correction techniques are discussed below.

### 1. Single Base Station Local Correction

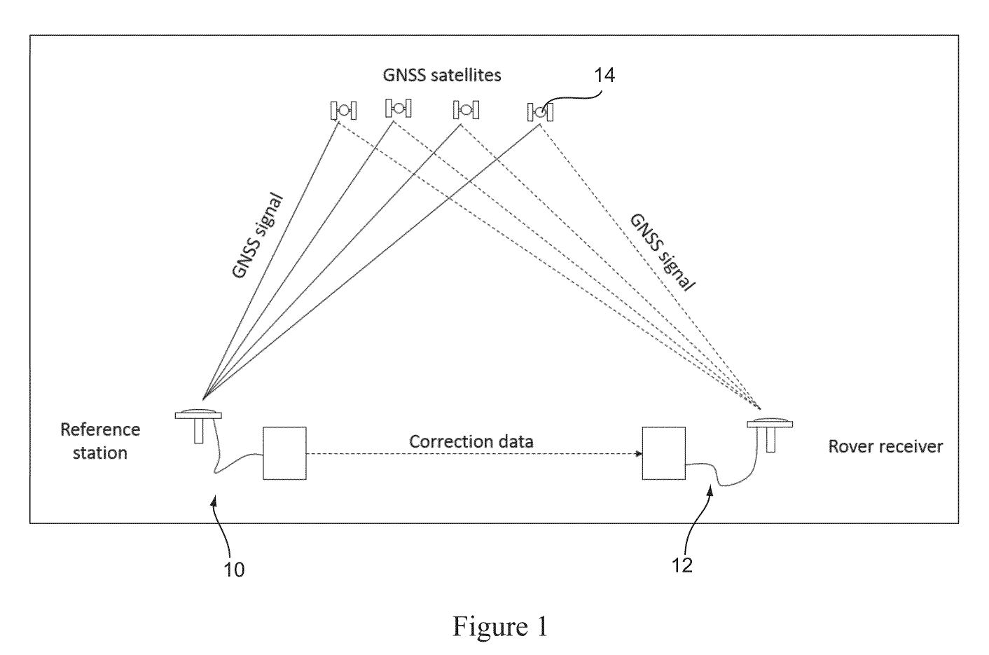

In this technique, as shown in FIG. 1, a reference receiver 10 is used at a known location in order to generate a correction stream that can be used by a second receiver 12 (which is often moving and, therefore, called the rover receiver) for which the position needs to be determined. In this case the correction data can comprise the reference station data 10, reduced by known quantities such as the geometric range between receiver and satellite 14 and satellite clock errors (typically referred to as DGPS/DGNSS), or the reference station raw measurements. When using the raw measurements as the contents of a real time correction stream, the positioning technique is often referred to as Differential RTK, or simply RTK. When generated using a single station 12, the correction stream can be considered to carry information about how to correct the satellite behavior (i.e., position and clocks) for that specific location. The same local corrective nature applies to atmospheric effects. Because the correction is only valid for that specific location, the accuracy of observation modeling using the single station correction degrades in proportion to how far the rover receiver is from the reference station. The effects that suffer the quickest de-correlation with respect to distance are the atmospheric effects, which are in most cases completely correlated between reference and rover under approximately 10 Kilometers, and become to certain degree, de-correlated for distances above 20 Kilometers.

### 2. Multiple Base Stations Regional Correction

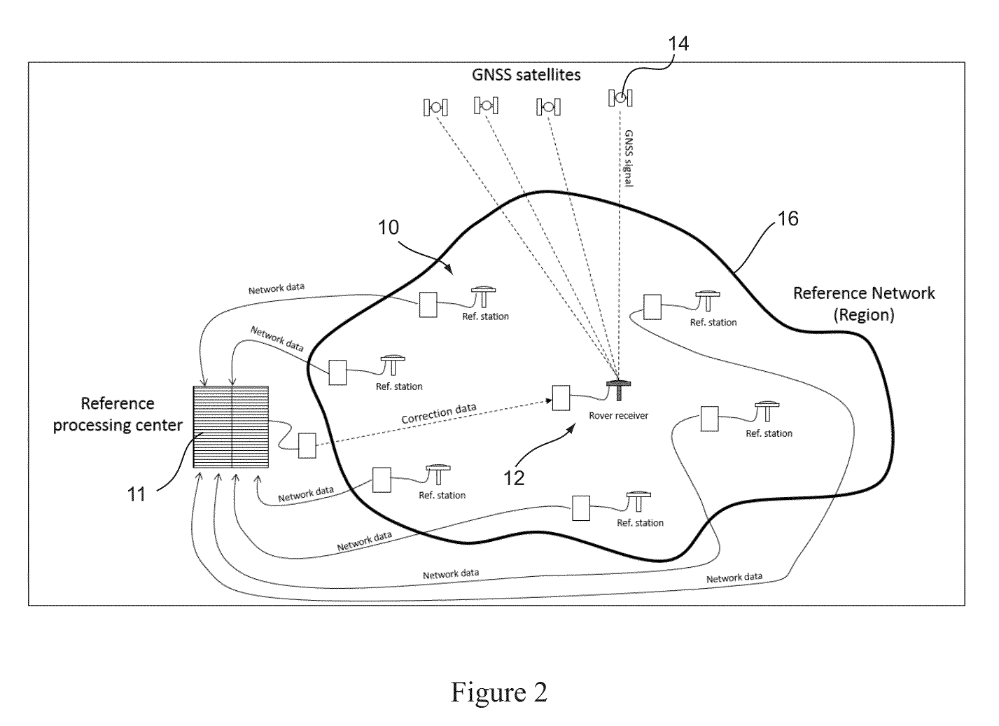

In this technique, as shown in FIG. 2, multiple reference receivers 10 are used at known locations inside a pre-defined region 16 in order to generate a correction stream that can be used by rover receivers 12 inside or near the network region 16. In this case, the correction data can take several forms depending on the type of network processor and the type of connection between rover receiver 12 and network processing center 11. The general idea behind using a regional network 16 of reference stations 10 is to model the GNSS observation effects that vary over that region, including the receiver-satellite geometric ranges and most importantly the atmospheric effects. Because the reference receivers 10 are typically distributed inside the region 16 of interested it is possible to generate models that predict the behavior of effects such as the ionospheric signal delay/advance across that same region. This type of information allows rover receivers 12 to operate at longer distance from reference stations 10 than it would be typically possible when using a single reference station, under same atmospheric conditions. When using corrections broadcast in real-time this technique is often referred to as Network RTK.

### 3. Multiple Base Stations Wide-Area Correction

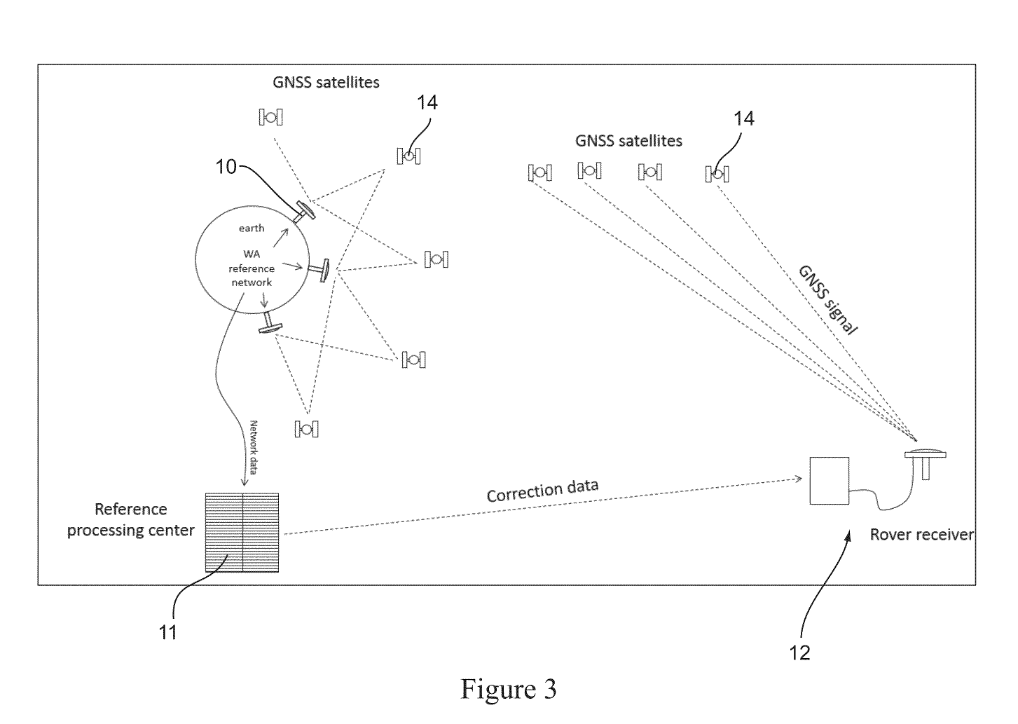

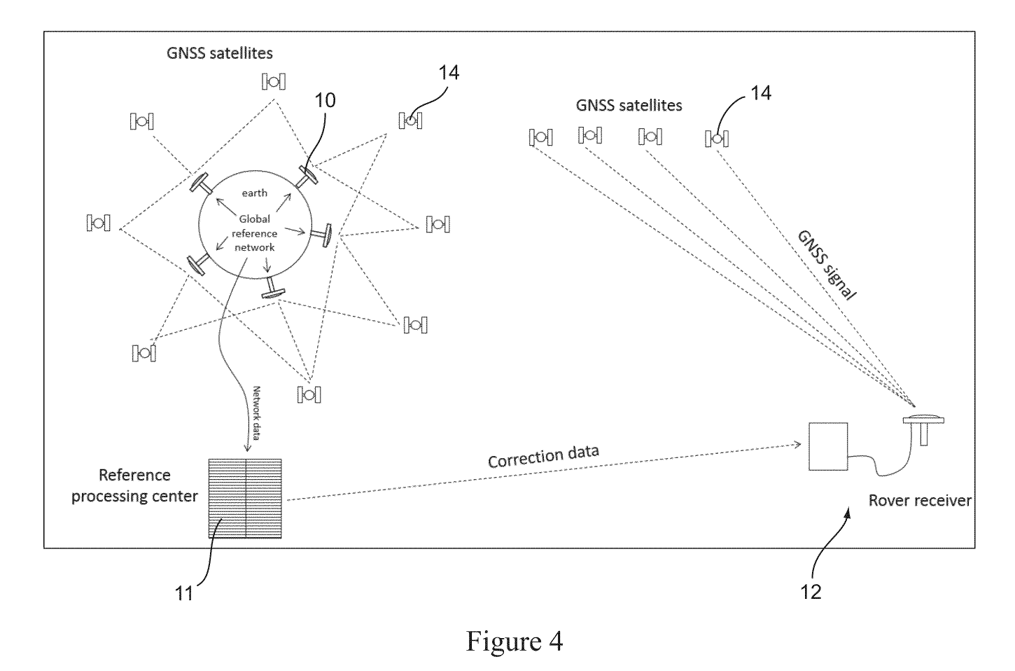

Similar to the regional network technique, in this approach, as shown in FIGS. 3 and 4, multiple reference receivers 10 are used at known locations in order to generate a correction stream that can be used by rover receivers 12. However, areas of coverage are typically whole countries, continents or even the entire globe, thus the term “wide-area”. Because of the extension of the networks coverage, the correction that is sent to rover receivers 12 is typically formulated in the so-called state-space domain. What this means is that rather than transmitting corrections that directly apply to the rover 12 observables, satellite 14 and environmental behavior data are transmitted instead. This data might include information used to derive satellite positions, satellite clock errors, atmospheric activity, and others. In the context of this text, wide-area might be considered a region that covers any amount of area, ranging from a fraction of the globe (FIG. 3) to a complete earth surface coverage (FIG. 4). In the latter, the wide-area corrections are also referred to as global corrections.

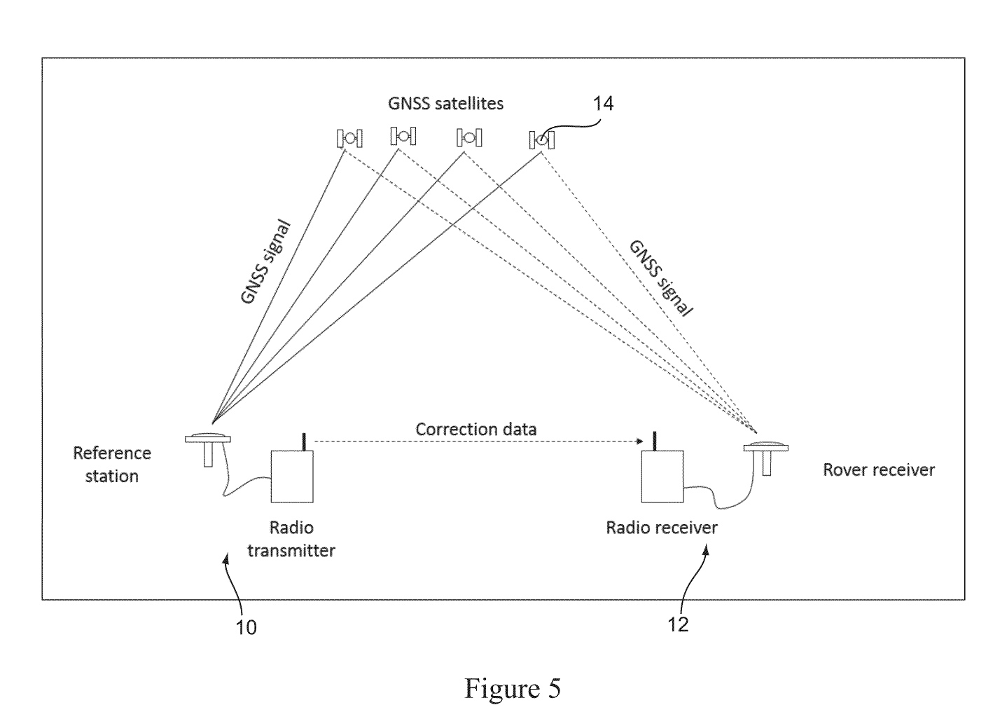

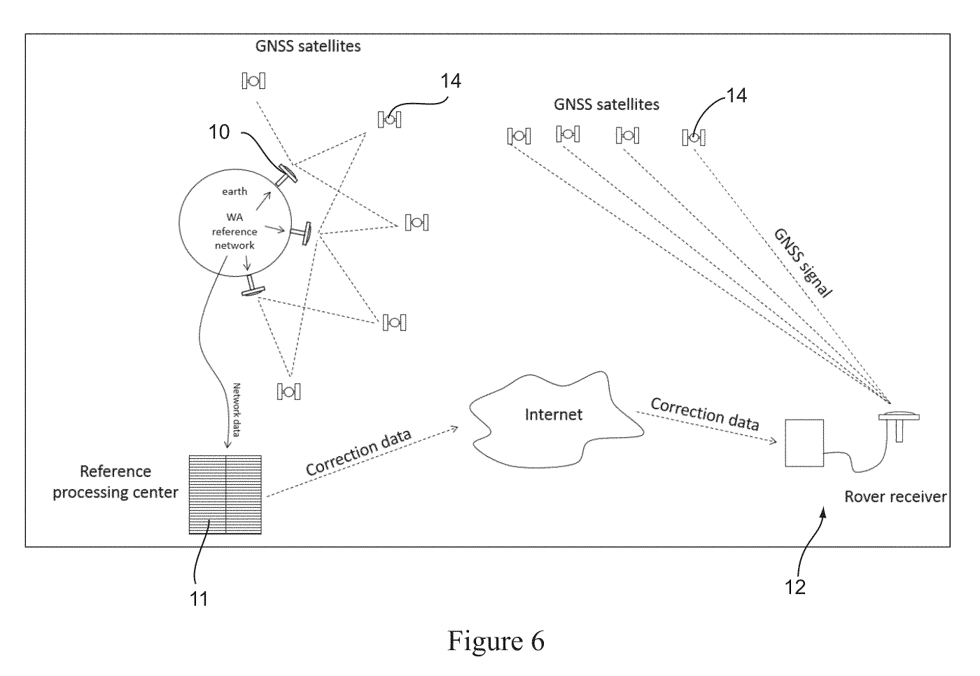

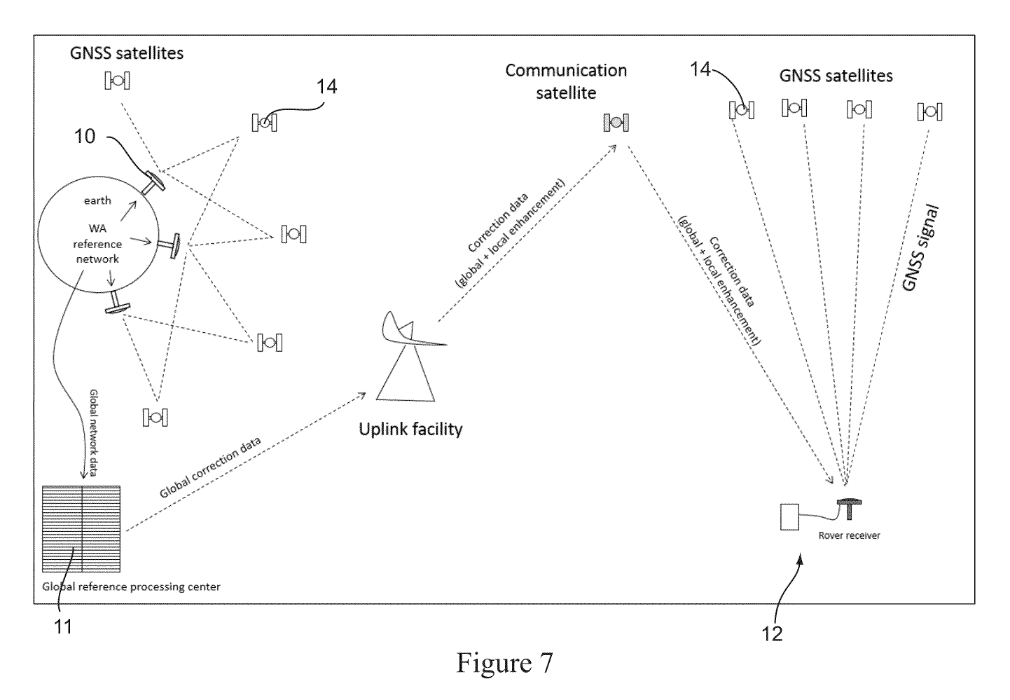

GNSS corrections can be transmitted by several means from their source to the rover receiver. Some examples of those means include Radio communication, as illustrated in FIG. 5; Internet, as illustrated in FIG. 6; and Satellite communication, as illustrated in FIG. 7.

### Problem To Be Solved

Full GNSS performance is only achieved when all GNSS observation model components can be accurately modelled or eliminated by means of combining GNSS observations. How well GNSS observation components are known, or how well they can be eliminated, determines the level of performance of a GNSS system. The two most fundamental GNSS position performance aspects are the convergence time (also often referred to as initialization time) and the positioning accuracy (or precision for certain applications). In the context of corrections it is convenient to separate the GNSS observation components into measurement biases, satellite geometric effects, and atmospheric effects.

The measurement biases are the differences between different types of measurements. These differences are often due to hardware delays during the transmission and reception of the GNSS signal, and, although they are not necessarily completely fixed over time, they are typically well behaved. Those biases can include difference between measurements of different frequencies for the same satellite and/or receiver, and difference between types of measurements (e.g. pseudorange and carrier-phase) for the same satellite and/or receiver.

Satellite geometric effects are, in this context, the components directly related to the satellite behavior. Those include the geometric distance between receiver and satellite antennas (typically postulated as a function of receiver and satellite coordinates), and the satellite clock error. Satellite position and clock error are ubiquitous components of the GNSS observation model. This means that these quantities are valid for any receiver able to observe that satellite. The ubiquitous nature of satellite orbit and clock errors makes these components to be very suitable for wide-area or global correction systems, since the same set of parameters of a given satellite is valid for anywhere on earth. On other hand, satellite clock errors change in a non-predictive manner over short periods of time. Because non-predictive short-term behavior, centimeter-level positioning can only be obtained when the clock correction data is transmitted at a reasonably high rate, with intervals of not more than few seconds.

Atmospheric effects are the impacts caused by earth's atmospheric layer on GNSS signals. These are typically divided into two major components, imposed by earth's ionospheric and tropospheric layers. These two layers interact with the GNSS signals in different ways. However the atmospheric effects have, in general, the characteristic of behaving differently over reasonably short distances. Not only the behavior of the atmosphere changes over space, its variation is often not easy to be properly modelled due to the non-regular features of the atmospheric physics. In order to properly model atmospheric effects a certain close proximity between monitoring sites is required, especially if intended for centimeter-level accurate positioning. Nevertheless, the atmospheric effects are very often predictable over short periods of time. Aside from special cases such as ionospheric scintillation, weather fronts, and solar/geomagnetic storms, the atmospheric effects can be assumed to behave reasonably well over time, with correlation times that can span over several seconds or even minutes in certain cases. The aforementioned single base and multi-base approaches suffer from these same effects.

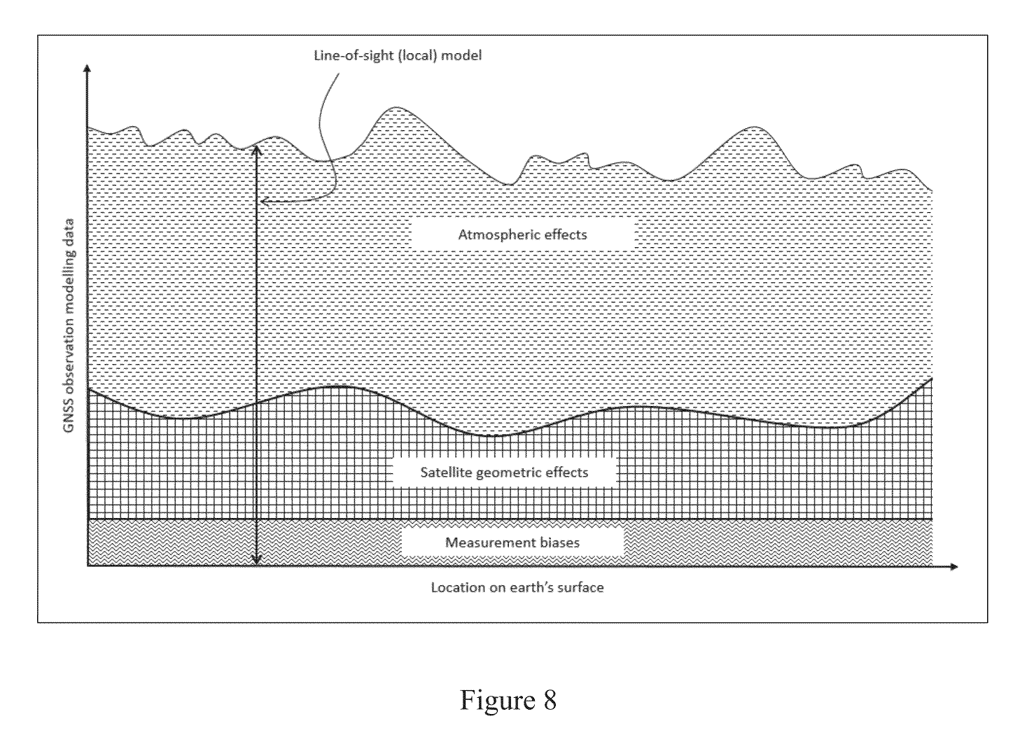

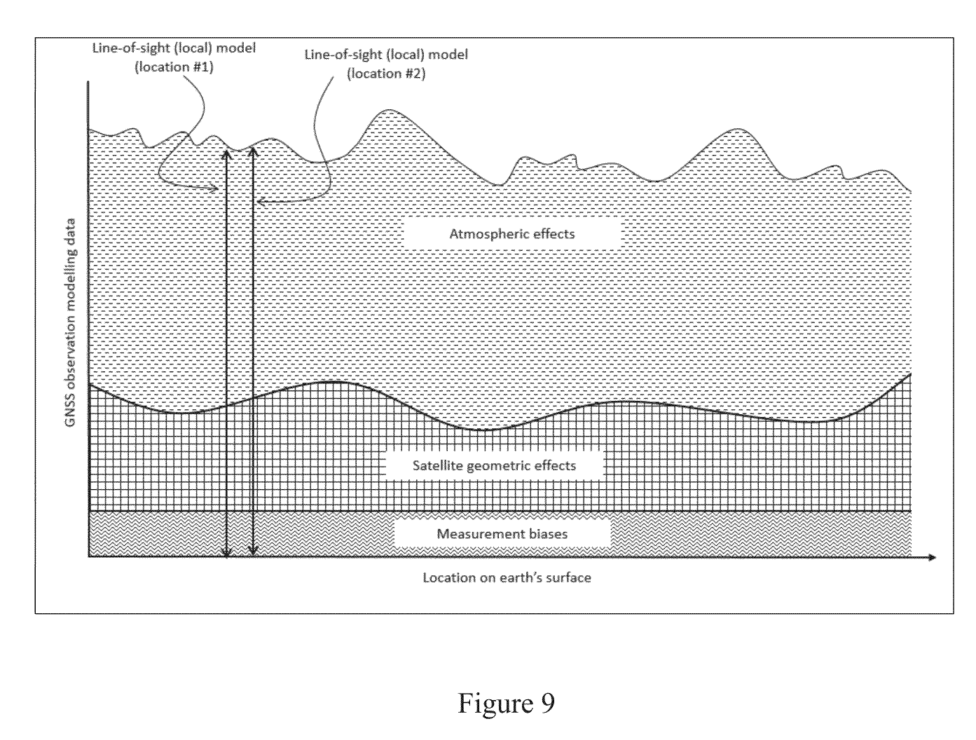

The satellite geometric effects and the atmospheric effects are somewhat orthogonal in terms of their predictability over time or space. While satellite geometric effects are predictable over space and hard to model over time (at least as far as satellite clocks go), atmospheric effects are, in general, predictable over time but harder to model over space. Systems that try to combine these two classes of effects into a single correction stream often do not take full advantage of their individual natures. FIG. 8 illustrates an example, where the three main effect components can be visualized as a function of location, or, in other words, over space. The figure also illustrates what a single-station local correction data would comprise, i.e., the full combination of all components for a specific location. FIG. 9 shows a case where a second and nearby local correction is generated. In that case, most of the information carried by the two correction data streams will be the same, however they still carry the full contents of the combined effects.

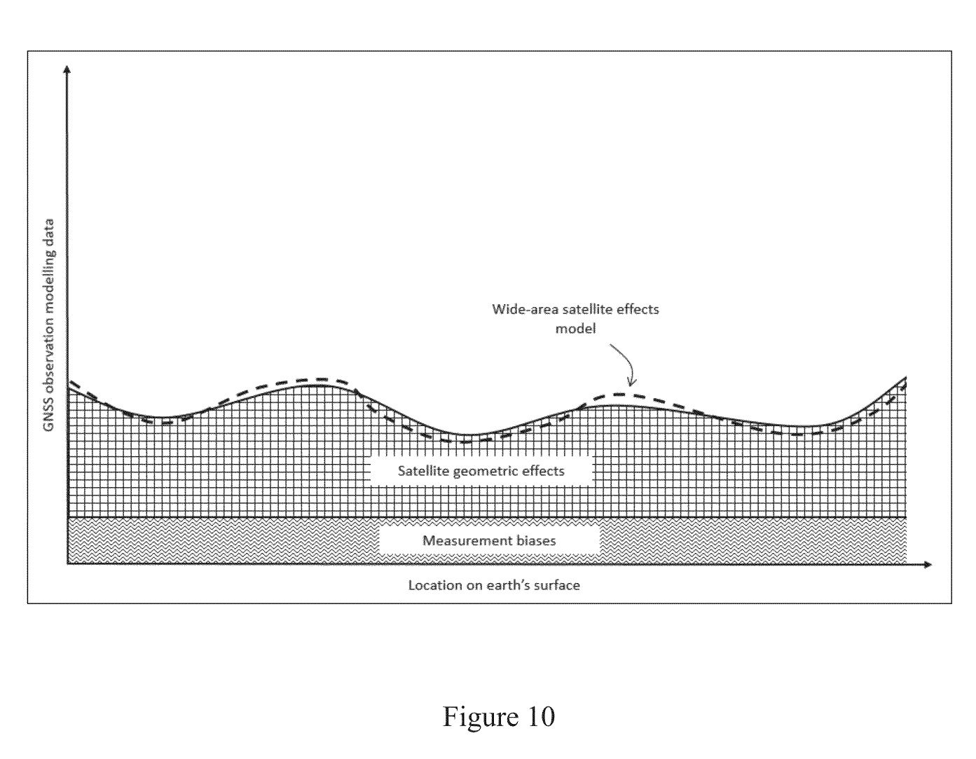

Wide-area, global and certain regional correction systems typically address the advantages of understanding the characteristics of the different components of the GNSS signal by separately modelling each of those components. FIG. 10 shows an example of a system that generates the satellite-related effects, but not atmospheric ones.

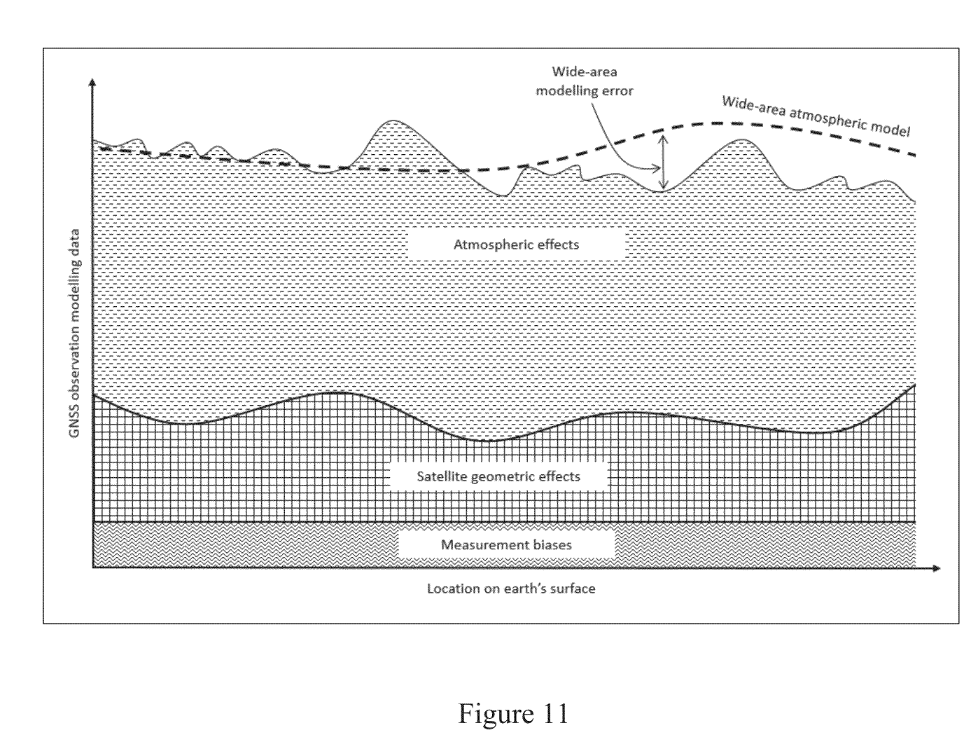

In addition to the satellite effects, atmospheric effects can also be modelled as part of the system solution. However in the case of wide-area and global systems, the atmospheric modelling is not accurate enough for achieving ultimate GNSS performance. By ultimate performance one should understand a performance that is reasonably comparable to one that which can be obtained using a local correction stream generated by a nearby reference station. The wide-area correction model is illustrated in FIG. 11.

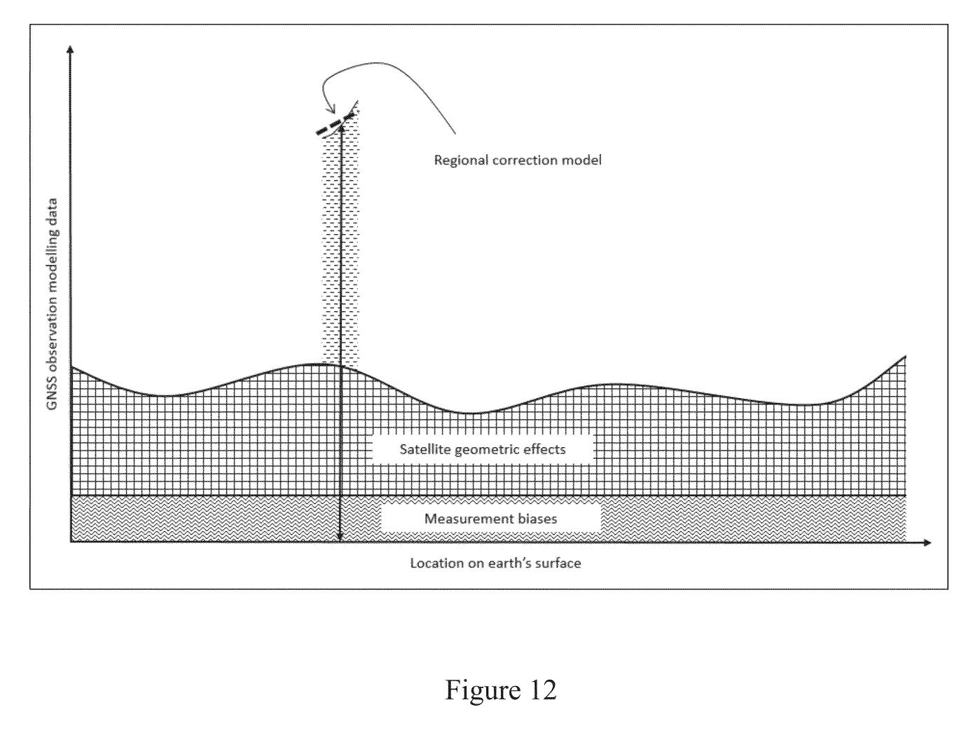

Certain regional streams separate the different components of the GNSS signal in their correction stream in order to optimize bandwidth usage. This is illustrated in FIG. 12. However, the correction stream is typically built so its components are meant to be used together and thus hard to be used separately. Another characteristic of such systems is that they typically require a network of monitoring stations as minimum condition to operate, in order to be able of successfully separating each observation component.

### Embodiments of a Locally Enhanced GNSS Wide-Area Augmentation System

The optimal combination of GNSS observation components is often not achieved by existing correction generation and dissemination systems. In order to do so it is necessary to have the correct balance on how the correction data information is distributed not only over time (or over bandwidth usage), but also over space. Finding the correct balance between these aspects yields into the optimal usage of GNSS data, where broad coverage areas are reached, and yet ultimate accuracies can be obtained at time and locations of interest. At the same time, the balanced combination of the correction components generation and dissemination leads to a minimization of the bandwidth required to achieve the desired performance.

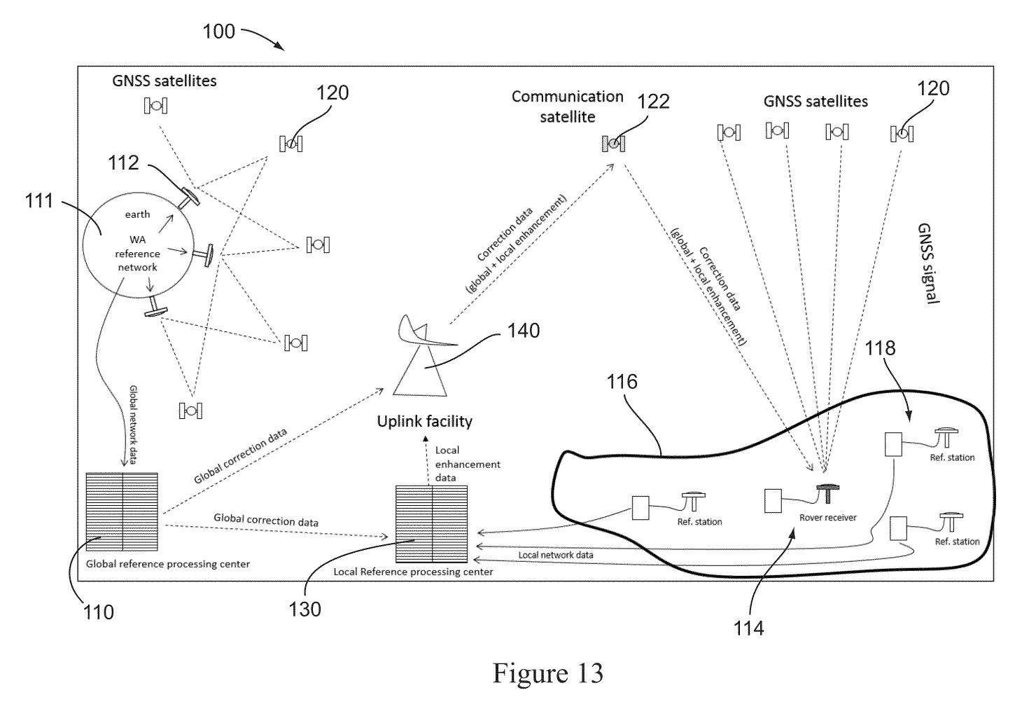

Referring to the drawings, FIG. 13 depicts a locally enhanced GNSS wide-area augmentation system 100 that has complete detachment of the GNSS signal components in terms of correction components. System 100 may include a global reference processing center 110 receiving global network data from a wide-area reference network 111 formed of wide-area reference stations 112 and GNSS satellites 120. System 100 may also include local reference network 116 having reference stations 118, a rover receiver 114 that communicates with GNSS satellites 120. Global reference processing center 110 receives global network data from wide-area reference network 111 and processes the data to generate global correction data. Global correction data is sent to an uplink facility and to a local reference processing center 130. Local network data is generated from local reference network 116, accounting for correction data between rover receiver 114 and reference stations 118. The local network data is sent to local reference processing center. Local enhancement processing center 130 then send local enhancement data to uplink facility 140. Uplink facility 140 may then send correction data formed of global correction data and local enhancement data to rover receiver 114 through a communication satellite 122. In this way, the local correction is a correction, or enhancement, to the wide-area correction.

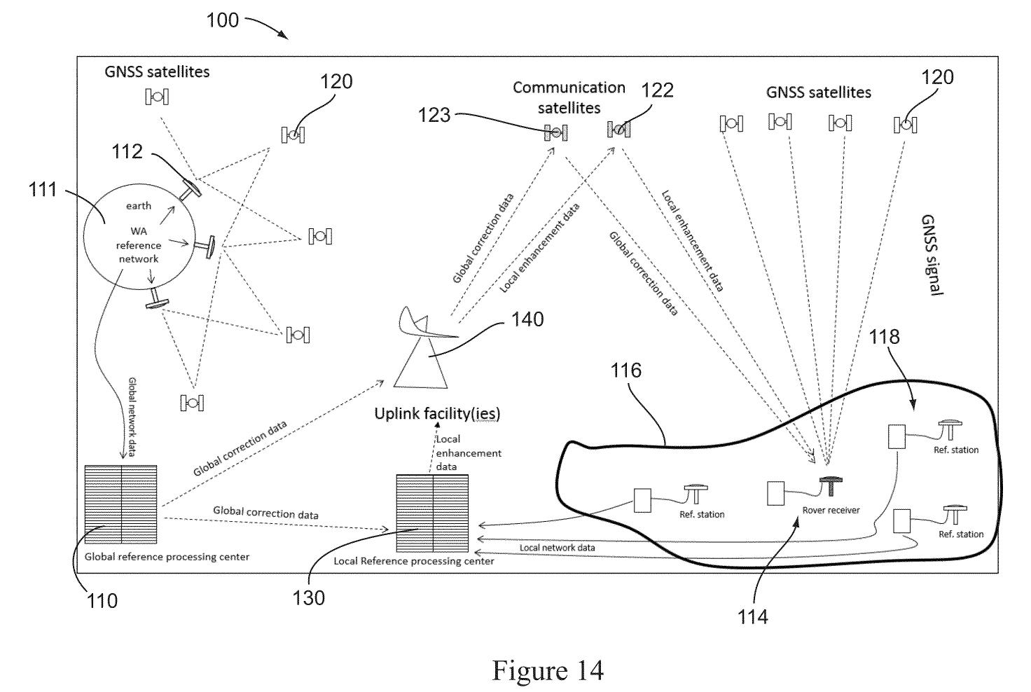

While FIG. 13 shows both wide-area and enhancement streams being transmitted via the same communication satellite 122, FIG. 14 depicts the same system 100 that further comprises a second communication satellite 123. In this system, global correction data may be sent from uplink facility 140 to rover receiver 114 through communication satellite 123 and local enhancement data may be sent from uplink facility 140 to rover receiver 114 through communication satellite 122. Other embodiments may send global correction data and local enhancement sate from uplink facility 140 to rover receiver 114 using different satellite channels. Further, in some embodiments, uplink facility 140 may be a plurality of uplink facilities 140 that operate in similar fashion.

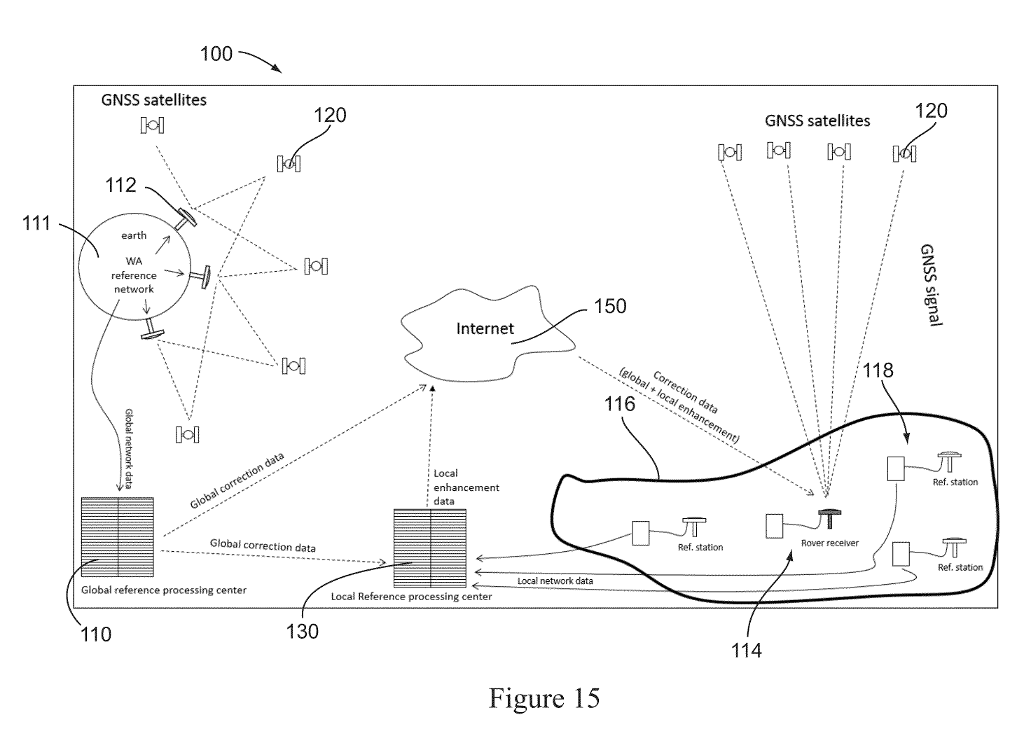

Referring to the drawings, FIG. 15 depicts a locally enhanced GNSS wide-area augmentation system 100 that has complete detachment of the GNSS signal components in terms of correction components. System 100 may include a global reference processing center 110 receiving global network data from a wide-area reference network 111 formed of wide-area reference stations 112 and GNSS satellites 120. System 100 may also include local reference network 116 having reference stations 118, a rover receiver 114 that communicates with GNSS satellites 120. Global reference processing center 110 receives global network data from wide-area reference network 111 and processes the data to generate global correction data. Local network data is generated from local reference network 116, accounting for correction data between rover receiver 114 and reference stations 118. The local network data is sent to local reference processing center 130. Global correction data is sent from global processing center 110 to local enhancement processing center 130 and to rover receiver 114 through Internet 150. Local enhancement processing center 130 sends local enhancement data to rover receiver 114 through Internet 150. In this way, correction data formed of global correction data and local enhancement data is transmitted to rover receiver 114 through Internet 150.

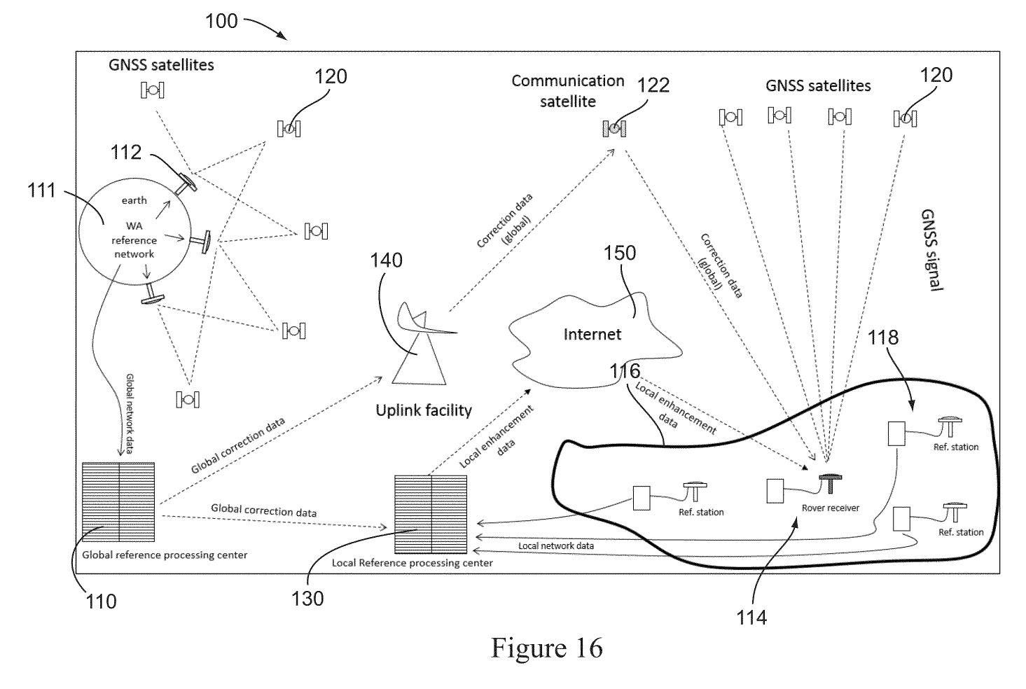

While FIG. 15 shows both wide-area and enhancement streams being transmitted via the Internet 150, FIG. 16 depicts the same system 100 that further comprises a second an uplink facility 140 and a communication satellite 122 and Internet 150. In this system, global correction data may be sent from uplink facility 140 to rover receiver 114 through communication satellite 122 and local enhancement data may be sent from uplink facility 140 to rover receiver 114 through Internet 150. It will be understood that the inverse is also possible with this dual transmission system.

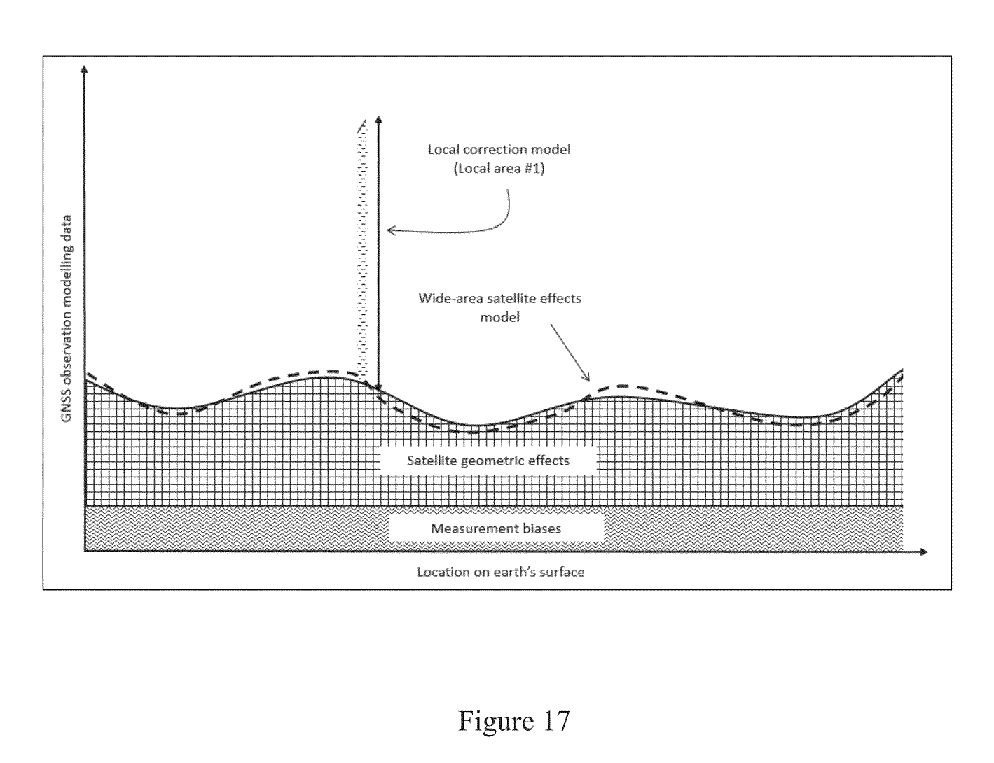

This concept can also be illustrated in terms of how it deals with the GNSS signal components, as shown in FIG. 17. While the wide-area correction can still be applied to any location under its coverage area, the GNSS performance is enhanced with a further local correction at certain locations. The local enhancement can be derived from one or more reference stations for a given localization. This system therefore combines several aspects of a GNSS correction system: The broad coverage of a wide-area (or global) correction system; The high accuracy of a local correction system; The lower latency possible for high speed and/or high rate corrections using local service; and The optimized correction bandwidth utilization over time and space.

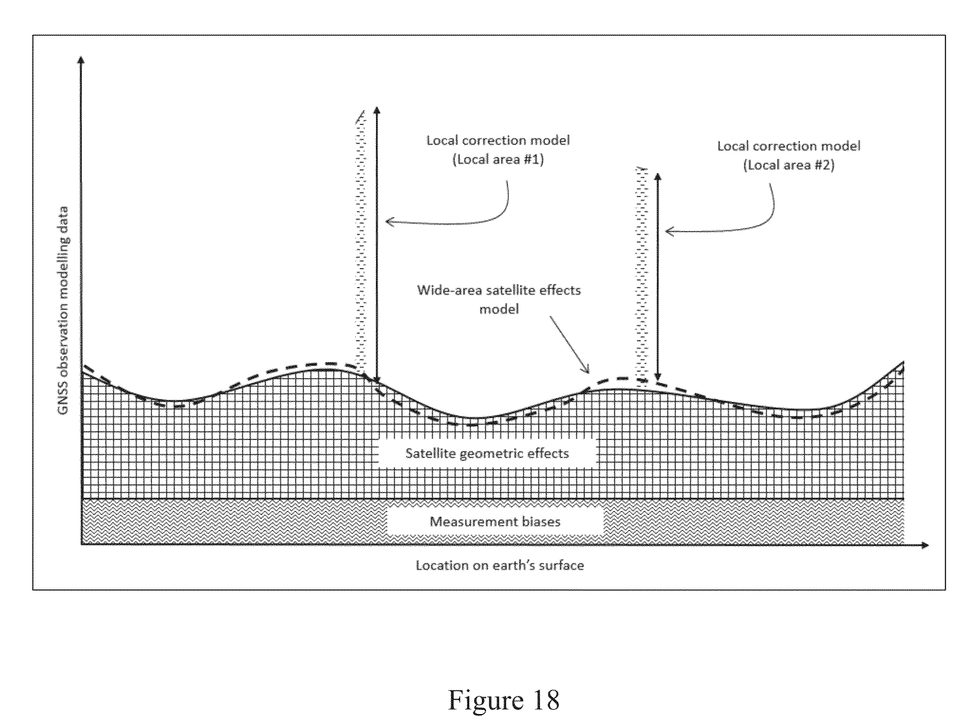

Because the wide-area is ubiquitous within its area of coverage, it can be used for more than one localized enhancement correction source, as illustrated in FIG. 18.

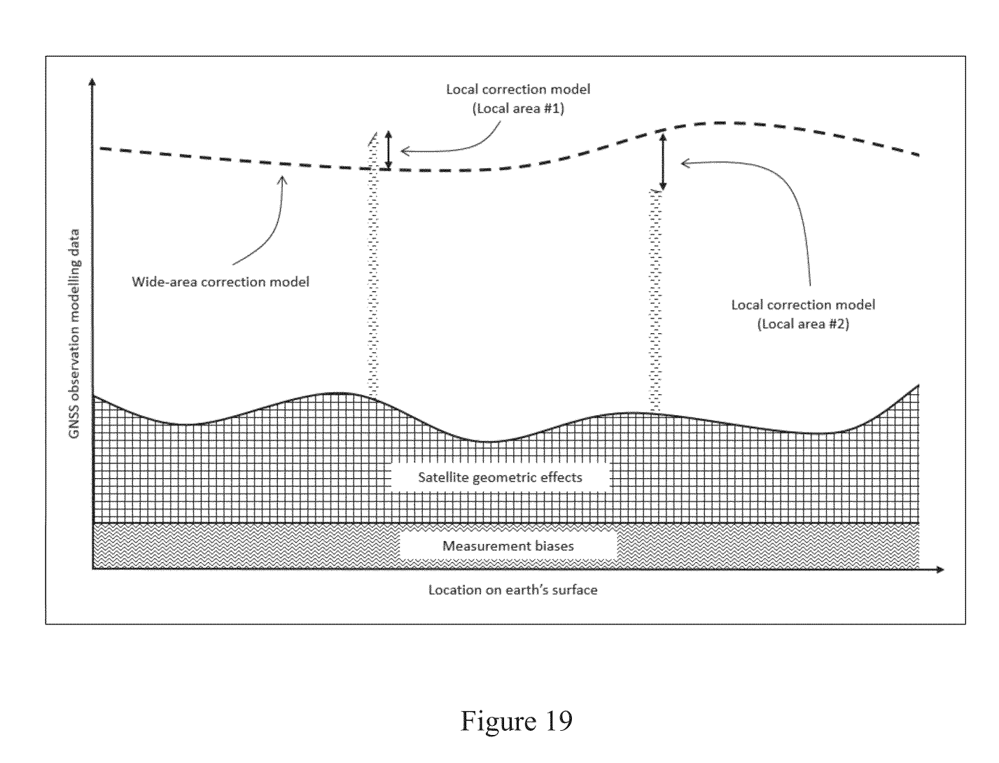

The local enhancement concept can also be applied to wide-area correction that contains atmospheric information such as an SBAS system, as illustrated in FIG. 19.

Because wide-area and local streams can use different sets of reference stations, and because the data processing is essentially different, the correction data generation latencies achieved by either system might be different. Added to the network data and processing there is also the latency introduced by the communication channel, which can also be different for each source, as pointed out earlier. Another source of difference for the latency of the corrections as perceived by the rover receiver is the size of the correction messages. Longer messages take longer to be received, decoded, and interpreted. Because of that the rate of corrections can also differ between wide-area and local corrections. With proper encoding and correction techniques the local correction stream can be built in a way to minimize the correction latency as perceived by the rover receiver, yet taking advantage of a potentially more latent wide-area correction source. In other words, the local augmentation can deliver corrections at a faster rate and shorter latency than what is delivered by the wide-area correction system. Such an approach still takes advantage of the existence of a wide-area stream, furthering the benefits for the user receiver with the augmentation of the localization system.

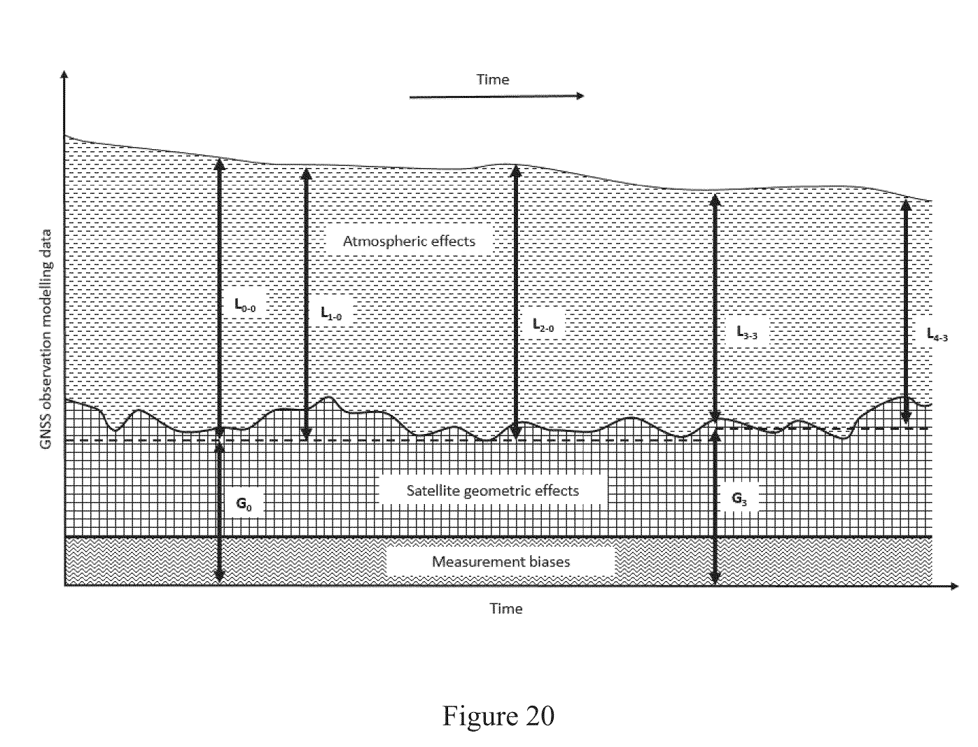

FIG. 20 shows an illustration of a setup where the local system is generating corrections at a different rate than the wide-area correction. In that illustration the local corrections L₀₋₀, L₁₋₀, and L₂₋₀ deliver the full correction for times 0, 1, and 2, using the wide-area correction G₀ generated for time 0. Local corrections L₃₋₃ and L₄₋₃ deliver the full correction for times 3 and 4, using the wide-area correction G₃ generated for time 3. Encoding and compressing methods can be used so that local correction can be used based not on a specific wide-area correction time-tag, but on a variety of them. For instance in the illustration below the local correction L₄₋₃ can be transmitted using such techniques that would allow its usage based on either wide-area correction G₀ or G₃. One of the benefits of such techniques is a better resilience of the system against message transmission losses, i.e., a user who didn't successfully receive correction G₃ would still be able to use L₄₋₃, based on G₀.

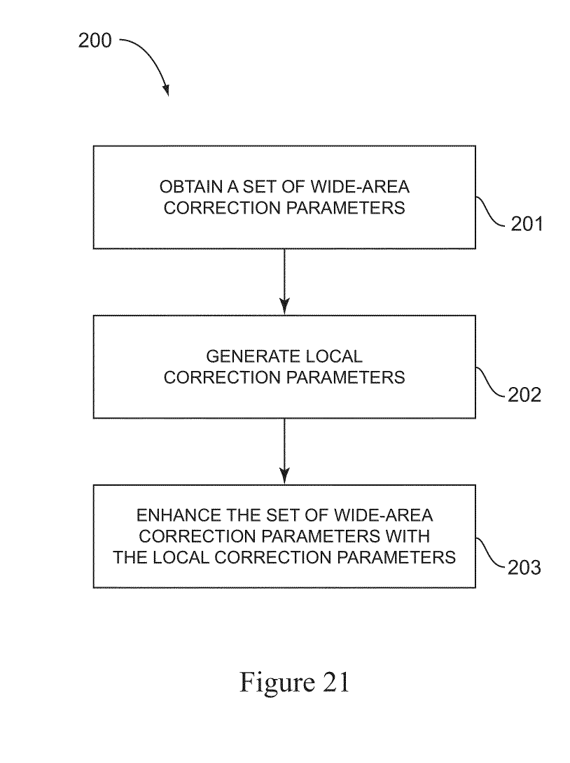

FIG. 21 depicts a method 200 of processing GNSS data to form locally enhanced GNSS wide-area corrections. Method 200 comprises obtaining a set of wide-area correction parameters from a wide-area network (Step 201); generating local correction parameters from a local reference network (Step 202); and enhancing the set of wide-area correction parameters with the local correction parameters (Step 203). The wide-area correction parameters may be valid world-wide and may be provided by a satellite-based augmentation system, including, but not limited to, a Wide Area Augmentation System (“WAAS”) system; a European Geostationary Navigation Overlay Service (“EGNOS”) system; a GPS-aided Geo-augmented (“GAGAN”) system; and a BeiDou system. The local correction parameters contain geodetic parameters such as, but not limited to, Datum transformation parameters; Coordinate system information; and Time system information.

In some embodiments, the local correction parameters contain auxiliary data, may include text messages, alerts, information codes, further correction messages; integrity information for the wide-area corrections, integrity information for the local corrections, quality indicators for the wide-area corrections; quality indicators for the local corrections; atmospheric activity information; and weather warnings and information data.

In some embodiments, the local correction data is made available over one or more communication channels, such as, but not limited to, an L-band satellite, a GNSS satellite, a radio transmitter, the Internet, a wifi network, a cellphone network, Bluetooth, satellite radio, a satellite telephone, a television signal; and a local radio signal.

In some embodiments, the global correction data is made available over one or more communication channels, such as, but not limited to, an L-band satellite, a GNSS satellite, a radio transmitter, the Internet, a wifi network, a cellphone network, Bluetooth, satellite radio, a satellite telephone, a television signal; and a local radio signal.

In some embodiments, the local correction data and the global correction data are made available through different communication channels comprising any combination of an L-band satellite, a GNSS satellite, a radio transmitter, the Internet, a wifi network, a cellphone network, Bluetooth, satellite radio, a satellite telephone, a television signal; and a local radio signal.

It will be understood that the global correction and the local correction may be transmitted at different rates and/or transmitted with different latencies. Further, in embodiments, the local reference network is a subset of the global reference network.

Method 200 may further comprise using at least one of the local correction data and the global correction data by a GNSS receiver to determine a set of parameters comprising antenna position, antenna acceleration, antenna velocity time, tropospheric delays, ionospheric delays, amount of water in the atmosphere, and amount of electrons in the atmosphere. This may be performed when the antenna of the GNSS receiver is moving.

Method 200 may also comprise transmitting the data of the GNSS receiver to the local processing center and use as an additional reference station; and transmitting the data of the GNSS receiver to the wide-area processing center and use as an additional reference station.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A method of processing GNSS data to from locally enhanced GNSS wide-area corrections, the method comprising:
obtaining a set of wide-area correction parameters from a wide-area network;
generating local correction parameters from a local reference network; and
enhancing the set of wide-area correction parameters with the local correction parameters.

2. The method of claim 1, wherein the wide-area correction parameters are valid world-wide.

3. The method of claim 2, wherein obtaining the set of wide-area correction parameters includes receiving global network data from the wide-area reference network.

4. The method of claim 3, wherein where the wide-area reference network is a satellite-based augmentation system.

5. The method of claim 4, wherein the satellite based augmentation system is one of a WAAS system, an EGNOS system, a GAGAN system, and a BeiDou System.

6. The method of claim 1, wherein the local correction parameters include geodetic parameters comprising datum transformation parameters, coordinate system information, and time system information.

7. The method of claim 6, wherein the local correction parameters include auxiliary data comprising at least one of text messages, alerts, information codes, further correction messages; integrity information for the wide-area corrections, integrity information for the local corrections, quality indicators for the wide-area corrections; quality indicators for the local corrections; atmospheric activity information; weather warnings and information data, and combinations thereof.

8. The method of claim 1, further comprising sending local correction parameters to a rover receiver over one or more communication channels comprising an L-band satellite, a GNSS satellite, a radio transmitter, the Internet, a wifi network, a cellphone network, Bluetooth, satellite radio, a satellite telephone, a television signal; and a local radio signal.

9. The method of claim 1, further comprising sending global correction parameters to a rover receiver over one or more communication channels comprising an L-band satellite, a GNSS satellite, a radio transmitter, the Internet, a wifi network, a cellphone network, Bluetooth, satellite radio, a satellite telephone, a television signal; and a local radio signal.

10. The method of claim 1, further comprising sending local correction parameters and global correction parameters to a rover receiver different communication channels comprising any combination of an L-band satellite, a GNSS satellite, a radio transmitter, the Internet, a wifi network, a cellphone network, Bluetooth, satellite radio, a satellite telephone, a television signal; and a local radio signal.

11. The method of claim 1, further comprising transmitting local correction parameters and global correction parameters to a rover receiver at different rates.

12. The method of claim 11, further comprising transmitting local correction parameters and global correction parameters to the rover receiver with different latencies.

13. The method of claim 12, further comprising using at least one of the local correction parameters and the global correction parameters by the rover receiver to determine a set of parameters comprising antenna position, antenna acceleration, antenna velocity time, tropospheric delays, ionospheric delays, amount of water in the atmosphere, and amount of electrons in the atmosphere

14. The method of claim 13, wherein an antenna of the rover receiver is moving.

15. The method of claim 1, wherein the local reference network is a subset of the global reference network.

16. A locally enhanced GNSS wide-area augmentation system comprising:
a global reference processing center;
a wide-area reference network formed of wide-area reference stations and GNSS satellites, wherein the global reference processing center is in communication with the wide-area reference network in order to receive global network data and form global correction data;
a local reference processing center;
a local reference network having reference stations and a rover receiver that communicate with GNSS satellites, wherein the local reference processing center is in communication with the local reference network in order to receive local network data and form local enhancement data; and
a communication link to send correction data formed of global correction data and local enhancement data to the rover receiver.

17. The system of claim 16, wherein the communication link is an uplink facility and a communication satellite.

18. The system of claim 16, wherein the communication link is one or more uplink facilities and two communication satellites, wherein a first communication satellite transmits global correction data and a second communication satellite transmits local enhancement data.

19. The system of claim 16, wherein the communication link is an Internet connection.

20. The system of claim 16, wherein the communication link comprises a combination of an uplink facility in communication with a communication satellite and an Internet connection.
